(19) United States
(12) Patent Application Publication
(10) Pub. No.: US 2020/0389866 A1
(43) Pub. Date: Dec. 10, 2020

(54) DEVICE AND METHOD FOR RELATIVE LOCALIZATION OF AT LEAST THREE NODES

(71) Applicant: Blinksight, Colombelles (FR)

(72) Inventors: Stéphane MUTZ, Cuverville (FR); Matthieu MUTZ, Caen (FR)

(73) Assignee: Blinksight, Colombelles (FR)

(21) Appl. No.: 16/604,922

(22) PCT Filed: Apr. 13, 2017
(86) PCT No.: PCT/FR2017/050884

§ 371 Date: Oct. 11, 2019

(51) Int. Cl. H04W 64/00

(52) U.S. Cl. CPC H04W 64/00

(57) ABSTRACT

The invention relates to a relative localization device comprising at least three nodes separated from each other. The node (A) being able to: trigger a round-trip message exchange (M1, M2) with a node (B); calculate a travel time (Tab) of the message (M1, M2); and emit a message (M5) containing an information (INF1) indicating the travel time (Tab). The node (C) being able to: trigger an exchange of messages (M3, M4) with node A for calculation of a travel time (Tac) of the message (M3, M4); receive the messages (M1, M2, M5); measure receive times (T1, T2) of the messages (M1, M2); and calculate a travel time (Tbc) of the message (M2) from the node (B) to the node (C) from the times (T1, T2), the time (Tac) and the information (INF1), contained in the message (M5).

### BACKGROUND

### Field

The invention relates to a device and method for localization of at least one node relative to two other nodes.

The field of application of the invention relates to devices comprising a plurality of telecommunication nodes exchanging messages between them in order to get position information for at least one of the nodes.

### SUMMARY

The goal of the invention is to get a device with which to position a third node relative to a first and a second node by taking the first node as position reference.

In general devices are known in the state-of-the-art, in which a first node is able to calculate the distance thereof relative to a second node by exchanging a message with the second node and measuring the round-trip travel time of the message. For a number N of nodes, the number of messages exchanged between the nodes in order to calculate all the distances between them varies with N².

A device of this type is known, for example, from the document WO 2015/101,674, in which a beacon emits a first message, a relay emits a second message after receiving the first message, a sensor measures the arrival times of the messages coming from the beacon and the relay, and a position calculator determines the position of one among the beacon, relay and sensor, from arrival time information and positions, known to the calculator, of the others among the beacon, relay and sensor.

This system therefore needs to know in advance the position of two of the nodes to know the position of the third node.

The documents U.S. Pat. Nos. 6,300,903 and 6,801,782 describe systems for locating a mobile phone based on four reference radio terminals of known positions.

The document FR-A-2,924,818 describes a radio localization system based on an ad hoc network comprising at least one first master node, and a plurality of second reference nodes, where said plurality is greater than or equal to two if the network is flat and greater than or equal to three if the network is three-dimensional, where the radio location system is suited for determining the position of at least one emitter, called free node, and where the master node is capable of:
determining the nodes present in the network during a discovery phase;
determining, during a localization phase, on the one hand, the respective distances separating the reference nodes and the master node and, on the other hand, the distances separating the reference nodes, and deducing from the distances thus determined relative positions of the reference nodes;
determining for each reference node the distance difference between the free node and the master node, on the one hand, and the free node and this reference node, on the other hand, and determining a relative position of the free node from the resulting relative positions of the reference nodes and distance differences.

This system requires during the localization phase, an exchange of messages between the master node and each reference node and another exchange of messages for identifying the distances between the pairs of reference nodes.

The document WO 2005/081012 A1 describes a similar system in which an ad hoc network with four base stations is created. Each base station sends a UWB signal to the three other base stations and measures the arrival time of the responses from them for calculating the distances between the four stations. The position of the target node is calculated by the fact that the target first sends a signal to the base stations and then each base station sends a response signal to the target after a known delay of the target.

The invention aims to get a device and a method for localization and nodes, with which to reduce the number of messages exchanged reduced in order to allow localization of at least one third node relative to the at least one first node and at least one second node with linear complexity.

For this purpose, a first object of the invention is a relative localization device comprising at least one first node, at least one second node and at least one third node, spaced apart from each other, characterized in that the first node (A) comprises a first message emitting and receiving unit (AER), able to trigger a round-trip first message exchange (M1, M2) with a second message emitting and receiving unit (BER), present in the second node (B), where the first node (A) comprises a first unit (AC) for calculation of a first travel time (Tab) of the first round-trip message (M1, M2) between the first node (A) and the second node (B), where the first emitting and receiving unit (AER) is also able to emit a third message (M5) containing a first information (INF1) indicating at least the first travel time (Tab).

According to an embodiment, the third node (C) comprises a third message emitting and receiving unit (CER), where the third or first message emitting and receiving unit (AER, CER) is able to trigger an exchange of second round trip messages (M3, M4) with the first or third message emitting and receiving unit (CER, AER), and where the third node (C) or first node (A) comprises a third calculation unit (CC) or the first calculation unit (AC), able to calculate a second travel time (Tac) of the second message (M3, M4) to or from the third node (C) and the first node (A).

According to an embodiment, the third message emitting and receiving unit (CER) is able to receive the first round-trip messages (M1, M2) and the third message (M5), where the third node (C) comprises a third time measurement unit (CMT) able to measure a first receiving time (T1) of the first outgoing message (M1) and a second receiving time (T2) of the first return message (M2).

According to an embodiment, the third calculation unit (C) is able to calculate a third travel time (Tbc) of the first return message (M2) from the second node (B) to the third node (C) from the first and second times (T1, T2), the second travel time (Tac) and the first information (INF1) indicating the first travel time (Tab), contained in the third message (M5).

According to an embodiment, the first calculation unit (AC) and/or the third calculation unit (CC) is able to calculate a first distance (Dab) between the first node (A) and the second node (B) from the first travel time (Tab) and/or the third calculation unit (CC) is able to calculate a second distance (Dac) between the first node (A) and the third node (C) from the second travel time (Tac) and/or the first calculation unit (AC) is able to calculate a second distance (Dac) between the first node (A) and the third node (C) from the second travel time (Tac) and/or the third calculation unit (CC) is able to calculate a third distance (Dbc) between the second node (B) and the third node (C) from the third travel time (Tbc).

Thanks to the invention, the number of messages emitted in the device is proportional to the number of nodes.

In particular, the invention makes use of the fact that the third node uses the exchange of round-trip messages between the first and second nodes and itself initiates an exchange of messages with the first node in order to know the three distances between the three nodes.

The invention therefore makes use of collaborative messages such as indicated above in order to reduce the number of messages emitted in the device. Thus, getting the three distances (Dab, Dac, Dbc) between the three nodes (A, B, C) only requires the exchange of five messages (M1, M2, M3, M4 and M5).

According to an embodiment, the relative localization device comprises at least one fourth node (D),

where the first message emitting and receiving unit (AER) of the first node (A) is able to trigger an exchange of fourth round trip messages (M10, M20) with a fourth message emitting and receiving unit (DER), present in the fourth node (D),

where the first calculation unit (AC) of the first node (A) is able to calculate a fourth travel time (Tad) of the fourth message (M10, M20) to or from the first node (A) and the fourth node (D), where the first emitting and receiving unit (AER) is suited to emit a fifth message (M50) containing a second information (INF2) indicating the fourth travel time (Tad),

the third message emitting and receiving unit (CER) is able to receive the fourth round trip messages (M10, M20) and the fifth message (M50),

the third time measurement unit (CMT) of the third node (C) is able to measure a third receiving time (T3) of the fourth outgoing message (M10) and a fourth receiving time (T4) of the fourth return message (M20),

the third calculation unit (CC) is able to calculate a fifth travel time (Tdc) of the fourth return message (M20) from the fourth node (D) to the third node (C) from the third and fourth times (T3, T4) of the second travel time (Tac) and the second information (INF2) indicating the fourth travel time (Tad), contained in the fifth message (M50).

According to an embodiment, the first calculation unit (AC) and/or the third calculation unit (CC) is able to calculate a fourth distance (Dad) between the first node (A) and the fourth node (D) from the fourth travel time (Tad) and/or the third calculation unit (CC) is able to calculate a fifth distance (Ddc) between the third node (C) and the fourth node (D) from the fifth travel time (Tdc).

According to an embodiment, the fifth message (M50) is combined with the third message (M5) and contains both the first information (INF1) indicating the first travel time (Tab) and the second information (INF2) indicating the fourth travel time (Tad).

According to an embodiment, the first or third message emitting and receiving unit (AER, CER) is able to emit a second return message (M4), after a second known delay (TRA) after receiving the second outgoing message (M3),

the second message emitting and receiving unit (BER) of the second node (B) is able to emit, after a first known delay (TRB) after receiving the first outgoing message (M1) and the first return message (M2),

the first node (A) comprises a first time measurement unit (AMT) for measuring a fifth emitting time (T5) of the first outgoing message (M1) by the first node (A) and a sixth receiving time (T6) of the first return message (M2) by the first node (A),

the first calculation unit (AC) is able to calculate, from the fifth emitting time (T5), the sixth receiving time (T6) and the first known delay (TRB), the first travel time (Tab) of the first outgoing message (M1) from the first node (A) to the second node (B) or of the first return message (M2) from the second node (B) to the first node (A),

the third or first time measurement unit (CMT, AMT) is able to measure a seventh emitting time (T7) of the second outgoing message (M3) by the third or first node (C, A) and an eighth receiving time (T8) for the second return message (M4) by the third or first node (C, A),

the third or first calculation unit (CC, AC) of the third or first node (C, A) is able to calculate, from the seventh emitting time (T7), the eighth receiving time (T8) and the second known delay (TRA), the second travel time (Tac) of the second outgoing message (M3) or the second return message (M4) between the first node (A) and the third node (C),

the third calculation unit (CC) is able to calculate the third travel time (Tbc), from the second travel time (Tac), the first receiving time (T1), the second receiving time (T2), the first known delay (TRB) and the first information (INF1) indicating the first travel time (Tab), contained in the third message (M5).

According to an embodiment, the fourth message emitting and receiving unit (DER) of the fourth node (D) is able to emit, after a fourth known delay (TRD) after receiving the fourth outgoing message (M10), the fourth return message (M20),

the first time measurement unit (AMT) of the first node (A) is able to measure a ninth emitting time (T9) of the fourth outgoing message (M10) by the first node (A) and the tenth receiving time (T10) of the fourth return message (M20) by the first node (A), the first calculation unit (AC) is able to calculate, from the ninth emitting time (T9), the tenth receiving time (T10) and the fourth known delay (TRD), the fourth travel time (Tad) of the fourth outgoing message (M10) from the first node (A) to the fourth node (D) or of the fourth return message (M20) from the fourth node (D) to the first node (A),

the third calculation unit (CC) being able to calculate the fifth travel time (Tdc), from the third and fourth times (T3, T4), of the second travel time (Tac), of the fourth known delay (TRD) and of the second information (INF2) indicating the fourth travel time (Tad), contained in the fifth message (M50).

According to an embodiment, the second outgoing message (M3) is combined with the first outgoing message (M1) and/or the fourth outgoing message (M10) is combined with the first outgoing message (M1).

According to an embodiment, the first travel time (Tab) is equal to

Tab={T6−T5−TRB}/2,

where Tab is the first travel time, T6 is the sixth receiving time, T5 is the fifth emitting time and TRB is the first known delay.

According to an embodiment, the second travel time (Tac) is equal to

Tac={T8−T7−TRA}/2,

where Tac is the second travel time, T8 is the eighth receiving time, T7 is the seventh emitting time and TRA is the second known delay.

According to an embodiment, the third travel time (Tbc) is equal to

Tbc=T2−T1−Tab−TRB+Tac,

where T2 is the second receiving time, T1 is the first receiving time, Tab is the first travel time obtained from the first information (INF1) contained in the third message (M5), TRB is the first known delay, and Tac is the second travel time.

According to an embodiment, the fourth travel time (Tad) is equal to

Tad={T10−T9−TRD}/2,

where T10 is the tenth receiving time, T9 is the ninth emitting time and TRD is the fourth known delay.

According to an embodiment, the fifth travel time (Tdc) is equal to

Tdc=T4−T3−Tad−TRD+Tac,

where Tdc is the fifth travel time, T4 is the fourth receiving time, T3 is the third receiving time, Tad is the fourth travel time obtained from the second information (INF2) contained in the fifth message (M50, M5), TRD is the fourth known delay.

Thanks to the invention, the number of messages emitted in the device following the addition of a fourth node (D) is only seven messages (M1, M2, M3, M4, M10, M20 and M5 or M50) in order to allow the exchange of five distances (Dab, Dac, Dbc, Dad and Ddc). This confirms the linear growth of the number of messages with the number of nodes.

A second object of the invention is a relative localization method for at least one third node relative to at least one first node and at least one second node, where the first, second and third nodes are separated from each other,

characterized in that the first node (A) emits a first outgoing message (M1), to which the second node (B) responds with a first return message (M2),

the first node (A) calculates a first travel time (Tab) for the first outgoing message (M1) or the first return message (M2) between the first node (A) and the second node (B);

the first node (A) emits a third message (M5) containing a first information (INF1) indicating at least the first travel time (Tab),

the third or first node (C, A) emits a second outgoing message (M3), to which the first or third node (A, C) responds with a second return message (M4),

the third or first node (C, A) calculates a second travel time (Tac) for the second outgoing message (M3) or the second return message (M4) between the third node (C) and the first node (A),

the third node (C) receives the first outgoing message (M1), the first return message (M2) and the third message (M5);

the third node (C) measures a first receiving time (T1) for the first outgoing message (M1) and a second receiving time (T2) for the first return message (M2),

the third node (C) calculates a third travel time (Tbc) of the first return message (M2) from the second node (B) to the third node (C) from the first and second times (T1, T2), the second travel time (Tac) and the first information (INF1) indicating the first travel time (Tab), contained in the third message (M5).

### BRIEF DESCRIPTION OF THE DRAWINGS/FIGURES

The invention will be better understood upon reading the following description, given solely as a nonlimiting example with reference to the attached drawings, where:

FIG. 1 schematically shows a localization device comprising three nodes, according to an embodiment of the invention;

FIG. 2 is a drawing of the localization device comprising four nodes, according to another embodiment of the invention;

FIG. 3 is a drawing of the localization device comprising four nodes, according to another embodiment of the invention;

FIG. 4 schematically shows a variant of the localization device from FIG. 1;

FIG. 5 schematically shows a variant of the localization device from FIG. 3.

### DETAILED DESCRIPTION

In the figures, the nodes A, B, C and/or D and/or other nodes E, F are telecommunication nodes. Each node A, B, C, D or others comprises respectively at least one antenna ANTA, ANTB, ANTC, ANTD, for emitting and receiving messages to and from the other nodes. The nodes are separated from each other in a medium, which is for example air. Thus, the communication between the nodes or between the antennas of the nodes is wireless, for example radio. The messages sent between the nodes can for example be impulse type or ultra-wideband messages. Each node is distinct from the other nodes and is located at a nonzero distance from the other nodes, at distances which at least for some are to be calculated. Each node can for example be a communication terminal or communication object. Each node can for example be a positioning terminal, allowing to position (calculate the coordinates) or to calculate one or more distances relative to one or more other nodes. Each node can be or comprise a message emitter-receiver. Each node can be contained in a housing or enclosure or container, which can be attached, by any appropriate attachment means, to a fixed or mobile object, or be part of this fixed or mobile object.

The messages are emitted omnidirectionally. Each message emitted by one node can be received by the other nodes. Each message emitted by one node can be addressed to all the other nodes. Thus, a message emitted by one node can be sent simultaneously to several other nodes. In the figures, the emitting of a single message by one node to several nodes is symbolized by a point and the receiving of a message by one of the other nodes is symbolized by the tip of an arrow, the message being symbolized by a segment.

### Localization Device and Method for Localization of at Least Three Nodes

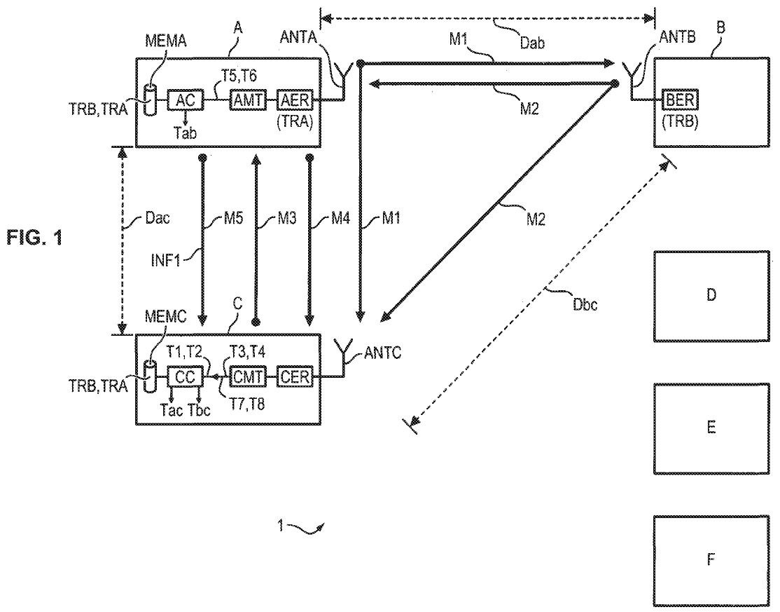

Referring to FIG. 1, the relative localization device 1 in which three distinct nodes A, B, C are provided is described first below.

According to an embodiment, a first exchange of messages M1, M2 is done between nodes A and B with which to calculate the first travel time Tab between them and a second exchange of messages M3, M4 is done between nodes C and A with which to calculate the second travel time Tac between them.

The first node A emits the first outgoing message M1 to the second node B and the third node C by the first message emitting and receiving unit AER thereof.

The second node B receives the first outgoing message M1 and then emits the first return message M2 to the first node A and the third node C by the second message emitting and receiving unit BER thereof.

With the first calculating unit AC thereof, the first node A calculates the first travel time Tab of the first outgoing message M1 from the first node A to the second node B or of the first return message from the second node B to the first node A.

Furthermore, the third node C receives the first outgoing message M1, which was emitted by the first node A, and the first return message M2, which was emitted by the second node B, by the third message emitting and receiving unit CER thereof. The third node C measures a first receiving time T1 for the first outgoing message M1 and the second receiving time T2 for the first returning message M2, with the third time measuring unit CMT.

The third node C emits the second outgoing message M3 with the third message emitting and receiving unit CER thereof. The second outgoing message M3 is received by the first emitting and receiving unit AER of the first node A, which sends back a second return message M4 in response, which is received by the third emitting and receiving unit CER of the third node C. With its third calculating unit CC, the third node C calculates the second travel time Tac of the second outgoing message M3 from the third node C to the first node A or of the first return message M4 from the first node A to the third node C.

The first node A emits, by its first emitting and receiving unit AER, a third message M5 containing a first information INF1 indicating the first travel time Tab. This third message M5 is received by the third emitting and receiving unit CER of the third node C. This first information INF1 can be or comprise the first travel time Tab and/or a first distance Dab calculated from the first travel time Tab.

With its third calculation unit CC, the third node C calculates a third travel time Tbc of the first return message M2 from the second node B to the third node C from the first and second times T1, T2 of the second travel time Tac and the first information INF1 indicating the first travel time Tab, contained in the third message M5.

In an embodiment, the first travel time Tab is used to calculate, in the first calculation unit AC and/or in the third calculation unit CC, a first distance Dab present between the first node A and the second node B, for example by multiplying this first travel time Tab by the known speed of propagation of the messages in the medium present between the nodes.

According to an embodiment, the first emitting and receiving unit AER of the first node A emits the second return message M4 after a second known delay TRA after receiving the second outgoing message M3 by this first unit AER.

Similarly, according to an embodiment, the second emitting and receiving unit BER of the second node B emits the second return message M2 after a first known delay TRB following receiving the first outgoing message M1 by this second unit BER.

According to an embodiment, the first node A may comprise a first memory MEMA in which the first known delay TRB and/or the second known delay TRA are prestored.

According to an embodiment, the third node C comprises a third memory MEMC in which the first known delay TRB and/or the second known delay TRA are prestored.

According to an embodiment, the first node A comprises a time measurement unit AMT for measuring a fifth emitting time T5 of the first outgoing message M1 by the first node A and the sixth receiving time T6 of the first return message M2 by the first node A. The first calculation unit AC of the first node A calculates, from the fifth emitting time T5, the sixth receiving time T6 and the first known delay TRB, the first travel time Tab of the first outgoing message M1 from the first node A to the second node B or the first travel time Tab of the first return message M2 from the second node B to the first node A. According to an embodiment, this first travel time Tab is calculated as being equal to Tab={T6−T5−TRB}/2.

According to an embodiment, the third time measurement unit CMT of the third node C measures a seventh emitting time T7 for the second outgoing message M3 by the third node C and an eighth receiving time T8 for the second return message M4 by the third node C. Thus the third calculation unit CC of the third node C calculates, from the seventh emitting time T7, the eighth receiving time T8 and the second known delay TRA, the second travel time Tac of the second outgoing message M3 from the third node C to the first node A or the first travel time Tac of the second return message M4 from the first node A to the third node C. According to an embodiment, this second travel time Tac is calculated as being equal to Tac={T8−T7−TRA}/2.

According to an embodiment, the third calculation unit CC of the third node C calculates the third travel time Tbc, from the second travel time Tac, the first receiving time T1, the second receiving time T2, the first known delay TRB and the first information INF1 indicating the first travel time Tab, contained in the third message M5. According to an embodiment, this third travel time Tbc is calculated as being equal to Tbc=T2−T1−Tab−TRB+Tac.

In an embodiment, the second travel time Tac is used to calculate, in the third calculation unit CC, a second distance Dac present between the first node A and the third node C, for example by multiplying this second travel time Tac by the known speed of propagation of the messages in the medium present between the nodes.

In an embodiment, the third travel time Tbc is used to calculate, in the third calculation unit CC, the third distance Dbc present between the second node B and the third node C, for example by multiplying this third travel time Tbc by the known speed of propagation of the messages in the medium present between the nodes.

Thus, in FIG. 1, calculating the three travel times Tab, Tac, Tbc and/or the three distances Dab, Dac, Dbc between the three nodes A, B, C only requires emitting five messages M1, M2, M3, M4, M5.

These travel times and/or distances can be used for calculating the position (or coordinates in one or several dimensions for the third node C and/or second node B relative to the first node A, which can serve as reference position. The localization device according to the invention can be part of a device for calculating the position of one or more of the nodes A, B, C.

For example, if A is defined by convention as the origin of a two-dimensional orthogonal reference frame for which the axis of the abscissa passes through B,

the position of A will be known as the origin of the coordinates (0, 0),

the position of B will be defined as the coordinates (x_b, 0) and will easily be determined by x_b=Dab,

the position of C defined as coordinates (x_c, y_c) will be determined using the following system of equations:

\sqrt{(x_c)²+(y_c)²}=Dac

\sqrt{(x_c−x_b)²+(y_c)²}=Dbc

Of course the invention can relate to three nodes or more than three nodes, like for example also the node D, and/or the node C and/or the node F and/or others, with which the node A and/or B and/or C can exchange messages.

### Localization Device and Method for Localization of at Least Four Nodes

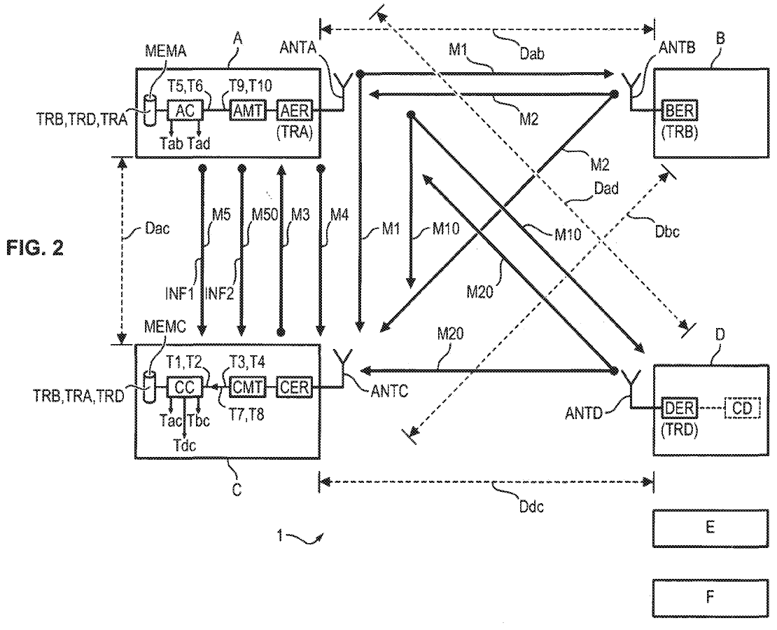

Referring to FIG. 2, an embodiment of the relative localization device in which four distinct nodes A, B, C, D are provided is described below.

Of course what was described above with reference to FIG. 1 for the nodes A, B and C is valid in the case of four nodes or more and therefore for the device from FIG. 2.

The process described in FIG. 1 for the third node C is realized in FIG. 2 not only for the third node C, but also for the fourth node D.

In FIG. 2, the first node A emits, by the first message emitting and receiving unit AER, a fourth outgoing message M10, which is received by a fourth message emitting and receiving unit DER of the fourth node D. In response to receiving this fourth outgoing message M10 by this fourth unit DER, the fourth node D emits by its fourth message emitting and receiving unit DER, a fourth return message M20.

The first node A receives the fourth return message M20 by the first message emitting and receiving unit thereof and calculates with the first calculation unit AC thereof a fourth travel time Tad for the fourth outgoing message M10 from the first node A to the fourth node D or a fourth travel time Tad for the fourth return message M20 from the fourth node D to the first node A.

In an embodiment, the fourth travel time Tad is used to calculate, in the first calculation unit AC and/or in the third calculation unit CC, a fourth distance Dad present between the first node A and the fourth node B, for example by multiplying this fourth travel time Tad by the known speed of propagation of the messages in the medium present between the nodes.

Furthermore, the first node A emits by its first message emitting and receiving unit AER a fifth message M50 containing a second information INF2 indicating the fourth travel time Tad. This second information INF2 can be or comprise the fourth travel time Tad and/or the calculated fourth distance Dad.

Furthermore, the fourth outgoing message M10 and the fourth return message M20, and also the fifth message M50 are received by the third message emitting and receiving unit CER of the third node C. The third node C measures a third receiving time T3 for the fourth outgoing message M10 and a fourth receiving time T4 for the fourth returning message M20, with the third time measuring unit CMT thereof.

Then, with its third calculation unit CC, the third node C calculates a fifth travel time Tdc of the fourth return message M20 from the fourth node D to the third node C from the third receiving time T3, fourth receiving time T4, the second travel time Tac and the second information INF2 indicating the fourth travel time Tad, contained in the fifth message M50.

According to an embodiment, the fifth travel time Tdc is used to calculate, in the third calculation unit CC, a fifth distance Ddc present between the third node C and the fourth node D, for example by multiplying this fifth travel time Tdc by the known speed of propagation of the messages in the medium present between the nodes.

According to an embodiment, the fourth node D emits the fourth return message M20 by its fourth message emitting and receiving unit DER after a fourth known delay TRD after receiving the fourth outgoing message M10 by this fourth unit DER.

According to an embodiment, the first node A may comprise a first memory MEMA in which the fourth known delay TRD is prestored.

According to an embodiment, the third node C comprises a third memory MEMC in which the fourth known delay TRD is prestored.

According to an embodiment, the first node A measures with the time measurement unit AMT thereof a ninth emitting time T9 of the fourth outgoing message M10 by the first node A and a tenth receiving time T10 of the fourth return message M20 by the first node A. The first node A calculates with the first calculation unit AC thereof, from the ninth emitting time T9, the tenth receiving time T10 and the fourth known delay TRD, the fourth travel time Tad for the fourth outgoing message M10 from the first node A to the fourth node D or the fourth travel time Tad for the fourth return message M20 from the fourth node D to the first node A. According to an embodiment, the fourth travel time Tad is calculated as being equal to Tad={T10−T9−TRD}/2.

According to an embodiment, the third node C calculates, with the third calculation unit CC thereof, the fifth travel time Tdc from the third receiving time T3, the fourth receiving time T4, the second travel time Tac, the fourth known delay TRD and the second information INF2 indicating the fourth travel time Tad, contained in the fifth message M50.

According to an embodiment, the fifth travel time Tdc is calculated as being equal to Tdc=T4−T3−Tad−TRD+Tac.

Thus, in FIG. 2, calculating the five travel times Tab, Tac, Tad, Tbc and Tdc and/or the five distances Dab, Dac, Dbc and Ddc between the four nodes A, B, C, D only requires emitting eight messages M1, M2, M3, M4, M5, M50, M10 and M20.

Of course the invention can relate to four nodes or more than four nodes, like for example also the node E and/or the node F and/or others, with which the node A and/or the node B and/or the node C and/or the node D can exchange messages.

### Variant of the Localization Device and of the Method for Localization of at Least Four Nodes

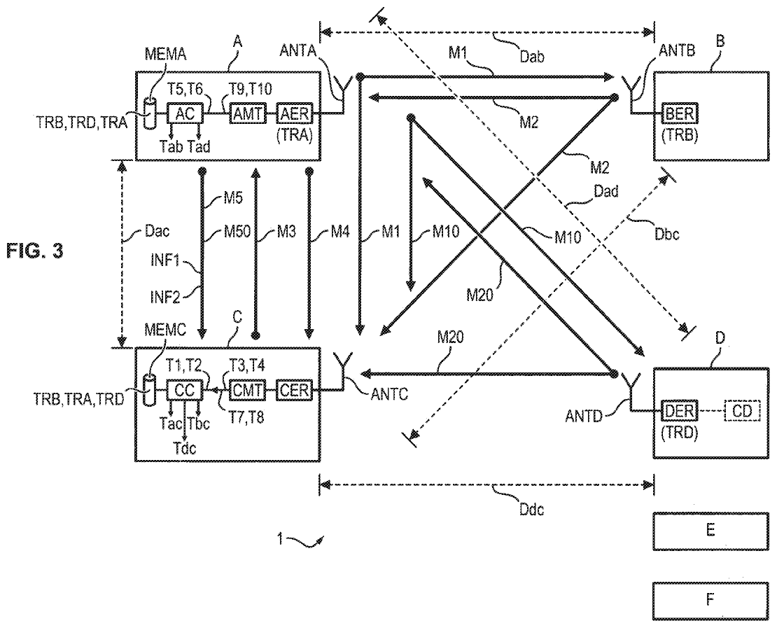

FIG. 3 shows a four-node localization device 1 conforming to the one described above with reference to FIG. 2, but in which, according to a preferred embodiment, the third message M5 is replaced by the fifth message M50 or is combined therewith. The message M5 or M50 therefore contains both the first information INF1 indicating the first travel time Tab and the second information INF2 indicating the fourth travel time Tad.

Thus, in FIG. 3, calculating the five travel times Tab, Tac, Tad, Tbc and Tdc and/or the five distances Dab, Dac, Dbc and Ddc between the four nodes A, B, C, D only requires emitting seven messages M1, M2, M3, M4, M50 (or M5), M10 and M20.

### Variants of the Localization Device and of the Method for Localization of at Least Three Nodes

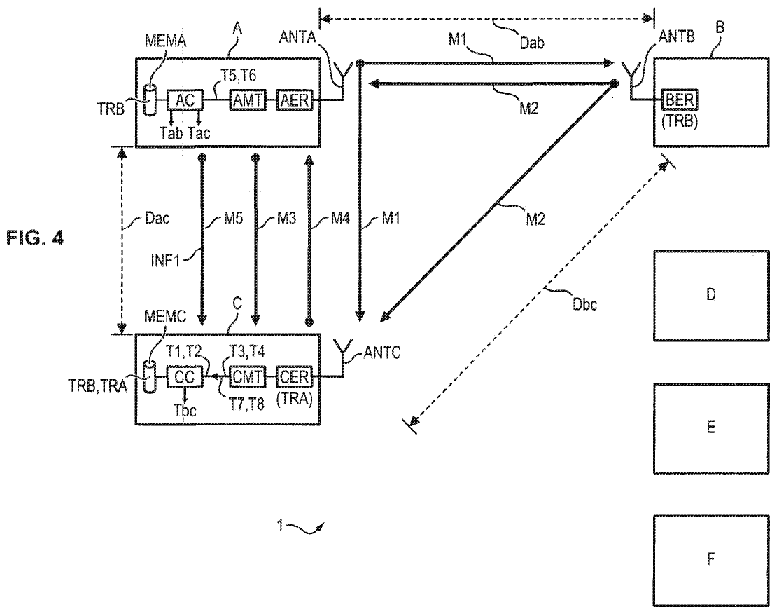

FIG. 4 represents a variant of the localization device 1 described above with reference to FIG. 1. What was described above with reference to FIG. 1 is valid for FIG. 4 and is modified by the variant described below.

In FIG. 4, the role of the first node A and the third node C is permuted as it relates to the second outgoing message M3, the second return message M4, the second travel time Tac, the second known delay TRA, the seventh emitting time T7, and the eighth receiving time T8. It is therefore the first node A which emits by its unit AER unit the second outgoing message M3 to the third node C. The third node C responds to the second outgoing message M3 by emitting the second return message M4 to the first node A. The unit AC of the first node A calculates the second travel time Tac of the second outgoing message M3 from the first node A to the third node C or the second travel time Tac of the second return message M4 from the third node C to the first node A.

According to an embodiment, the third message emitting and receiving unit CER is able to emit, after a second known delay TRA following receiving the second outgoing message M3, the second return message M4.

According to an embodiment, the first time measurement unit AMT is able to measure a seventh emitting time T7 for the second outgoing message M3 by the first node A and an eighth receiving time T8 for the second return message M4 by the first node A. The first calculation unit AC of the first node A is able to calculate, from the seventh emitting time T7, the eighth receiving time T8 and the second known delay TRA, the second travel time Tac of the second outgoing message M3 from the first node A to the third node C or of the second return message M4 from the third node C to the first node.

According to an embodiment, the first emitting and receiving unit AER is able to emit the third message M5 containing a first information INF1 indicating at least the first travel time Tab and the second travel time Tac.

In another variant of the localization device 1 given with reference to FIG. 4, the second outgoing message M3 is combined with the first outgoing message M1 and the first known delay TRB is chosen different from the second known delay TRA such that the second return message M4 is emitted by the third node C at a different time than the emitting of the first return message M2 by the second node B. For example, the second known delay TRA is chosen longer or equal to the first known delay TRB increased by the maximum travel time corresponding to the longest distance allowed between two nodes.

### Variant of the Localization Device and of the Method for Localization of at Least Four Nodes

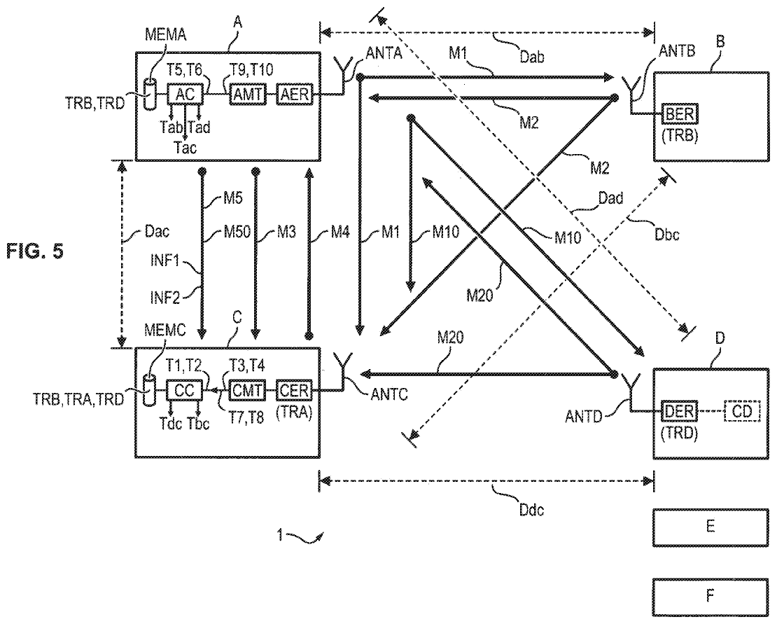

FIG. 5 represents a variant of the localization device 1 described above with reference to FIG. 3. What was described above with reference to FIG. 3 is valid for FIG. 5 and is modified by the variant described below.

In FIG. 5, the role of the first node A and the third node C is permuted as it relates to the second outgoing message M3, the second return message M4, the second travel time Tac, the second known delay TRA, the seventh emitting time T7, and the eighth receiving time T8. It is therefore the first node A which emits by its unit AER unit the second outgoing message M3 to the third node C. The third node C responds to the second outgoing message M3 by emitting the second return message M4 to the first node A. The unit AC of the first node A calculates the second travel time Tac of the second outgoing message M3 from the first node A to the third node C or the second travel time Tac of the second return message M4 from the third node C to the first node A.

According to an embodiment, the first emitting and receiving unit AER is able to emit the third message M5 containing a first information INF1 indicating at least the first travel time Tab and the second travel time Tac. For example, the third message M5 contains both the first information INF1 indicating at least the first travel time Tab and the second travel time Tac, and the second information INF2 indicating the fourth travel time Tad.

According to an embodiment, the third message emitting and receiving unit CER is able to emit, after a second known delay TRA after receiving the second outgoing message M3, the second return message M4.

According to an embodiment, the first time measurement unit AMT is able to measure a seventh emission time T7 for the second outgoing message M3 by the first node A and an eighth receiving time T8 for the second return message M4 by the first node A. The first calculation unit AC of the first node A is able to calculate, from the seventh emitting time T7, the eighth receiving time T8 and the second known delay TRA, the second travel time Tac of the second outgoing message M3 from the first node A to the third node C or of the second return message M4 from the third node C to the first node A.

In another variant of the localization device 1 described above with reference to FIG. 2, what was described above is modified by the fact that the first emitting and receiving unit AER is able to emit the third message M5 containing the first information INF1 indicating at least the first travel time Tab and the second travel time Tac, and the message M50, distinct from the message M5, and containing the second information INF2 indicating the fourth travel time Tad.

In another variant of the localization device described above with reference to FIG. 5, the second outgoing message M3 and/or the fourth outgoing message M10 is combined with the first outgoing message M1, and the second known delay TRA and/or the fourth known delay TRD is chosen different from the first known delay TRB such that the second return message M4 and/or the fourth return message M20 are emitted by the third node C and/or the fourth node D at a different emitting time than the first return message M2 by the second node B and/or that the fourth return message M20 is emitted by the fourth node D at a different emitting time than the second return message M4 by the third node C. For example, the second known delay TRA is chosen as being equal to the first known delay TRB increased by the maximum travel time corresponding to the longest distance allowed between two nodes and the fourth known delay will be chosen as longer or equal to the first known delay TRB increased by twice the maximum travel time corresponding to the longest distance allowed between two nodes.

In the present description, generally:
several first nodes may be provided as first node A;
several second nodes may be provided as second node B;
several third nodes may be provided as third node C;
several fourth nodes may be provided as fourth node D;
the fourth node D may comprise means with which to calculate a travel time Tbd between the nodes B and D and/or a distance Dbd between the nodes B and D, and/or a travel time Tdc between the nodes C and D and/or a distance Ddc between the nodes C and D, where these means are analogous to what was described above for the node C;
the node D and the nodes E, F or others may each be analogous to the node C;
the third node C and/or the second node B and/or the fourth node D may also send in one or several messages the travel time Tbc and/or the distance Dbc and/or the travel time Tab and/or the distance Tab and/or the travel time Tac and/or the distance Dac and/or a travel time Tbd between the nodes B and D and/or a distance Dbd between the nodes B and D, and/or a travel time Tdc between the nodes C and D and/or a distance Ddc between the nodes C and D and/or the travel time Tad and/or the distance Dad, for communicating them to other nodes. Thus all nodes have this information.
the node B can calculate the distance Dab from the travel time Tab received in the message M5 with the calculation unit thereof;
the node B can calculate the distance Dbc with the calculation unit thereof;
the node B can calculate the distance Dbd with the calculation unit thereof.

According to an embodiment, the first node A, the second node B, the third node C and/or the fourth node D is able to calculate by its first calculation unit AC and/or its second calculation unit BC and/or its third calculation unit CC and/or its fourth calculation unit CD at least one arrival angle of the message M1, M2, M3, M4, M10 and/or M20. Thus each node is able to determine a relative angle of orientation referenced to the other nodes.

For example, the third node C can get an angle of orientation relative to the first node A, the second node B and the fourth node D. For example, the one or several messages indicated above, received by one of the nodes A, B, C, D or others can be used to measure, by an angle measurement unit which this node comprises, an arrival angle for this message received by this node.

An object of the invention is also a localization method comprising one or more steps described above and/or the first node A, and/or the second node B, and/or the third node C and/or the fourth node D. According to an embodiment, the localization method is implemented using the localization device.

1. A relative localization device comprising at least one first node, at least one second node and at least one third node, away from each other,
characterized in that the first node (A) comprises a first message emitting and receiving unit (AER), able to trigger a round-trip first message exchange (M1, M2) with the second message emitting and receiving unit (BER), present in the second node (B), where the first node (A) comprises a first unit (AC) for calculation of a first travel time (Tab) of the first round-trip message (M1, M2) between the first node (A) and the second node (B), where the first emitting and receiving unit (AER) is able to emit a third message (M5) containing a first information (INF1) indicating at least the first travel time (Tab);
the third node (C) comprising a third message emitting and receiving unit (CER), where the third or first message emitting and receiving unit (AER, CER) is able to trigger an exchange of second round trip messages (M3, M4) with the first or third message emitting and receiving unit (CER, AER), and where the third node (C) or first node (A) comprises a third calculation unit (CC) or the first calculation unit (AC), able to calculate a second travel time (Tac) for the second round trip message (M3, M4) between the third node (C) and the first node (A),
the third message emitting and receiving unit (CER) being able to receive the first round-trip messages (M1, M2) and the third message (M5), where the third node (C) comprises a third time measurement unit (CMT) able to measure a first receiving time (T1) of the first outgoing message (M1) and a second receiving time (T2) of the first return message (M2);
the third calculation unit (CC) being able to calculate a third travel time (Tbc) of the first return message (M2) from the second node (B) to the third node (C) from the first and second times (T1, T2), the second travel time (Tac) and the first information (INF1) indicating the first travel time (Tab), contained in the third message (M5).

2. The device according to claim 1 characterized in that the first calculation unit (AC) and/or the third calculation unit (CC) is able to calculate a first distance (Dab) between the first node (A) and the second node (B) from the first travel time (Tab),
the first calculation unit (AC) and/or the third calculation unit (CC) is able to calculate a second distance (Dac) between the first node (A) and the third node (C) from the second travel time (Tac),
the third calculation unit (CC) is able to calculate a third distance (Dbc) between the second node (B) and the third node (C) from the third travel time (Tbc).

3. The device according claim 1, further comprising a fourth node (D),
where the first message emitting and receiving unit (AER) of the first node (A) is able to trigger an exchange of fourth round trip messages (M10, M20) with a fourth message emitting and receiving unit (DER), present in the fourth node (D),
the first calculation unit (AC) of the first node (A) being able to calculate a fourth travel time (Tad) of the fourth round-trip message (M10, M20) between the first node (A) and the fourth node (D), the first emitting and receiving unit (AER) being able to transmit a fifth message (M50) containing a second information (INF2) indicating the fourth travel time (Tad),
the third message emitting and receiving unit (CER) is able to receive the fourth round-trip messages (M10, M20) and the fifth message (M50);
the third time measurement unit (CMT) of the third node (C) is able to measure a third receiving time (T3) of the fourth outgoing message (M10) and a fourth receiving time (T4) of the fourth return message (M20),
the third calculation unit (CC) is able to calculate a fifth travel time (Tdc) of the fourth return message (M20) from the fourth node (D) to the third node (C) from the third and fourth times (T3, T4) of the second travel time (Tac) and the second information (INF2) indicating the fourth travel time (Tad), contained in the fifth message (M50).

4. The device according to claim 3, characterized in that the first calculation unit (AC) and/or the third calculation unit (CC) is able to calculate a fourth distance (Dad) between the first node (A) and the fourth node (D) from the fourth travel time (Tad),
the third calculation unit (CC) is able to calculate a fifth distance (Ddc) between the third node (C) and the fourth node (D) from the fifth travel time (Tdc).

5. The device according to claim 3, characterized in that the fifth message (M50) is combined with the third message (M5) and contains both the first information (INF1) indicating the first travel time (Tab) and the second information (INF2) indicating the fourth travel time (Tad).

6. The device according claim 1, characterized in that the first or third message emitting and receiving unit (AER, CER) is able to emit the second return message (M4), after a second known delay (TRA) following receiving the second outgoing message (M3),
the second message emitting and receiving unit (BER) of the second node (B) is able to emit, after a first known delay (TRB) following receiving the first outgoing message (M1), the first return message (M2),
the first node (A) comprising a time measurement unit (AMT) for measuring a fifth emitting time (T5) of the first outgoing message (M1) by the first node (A) and a sixth receiving time (T6) of the first return message (M2) by the first node (A),
the first calculation unit (AC) is able to calculate, from the fifth emitting time (T5), the sixth receiving time (T6) and the first known delay (TRB), the first travel time (Tab) of the first outgoing message (M1) from the first node (A) to the second node (B) or of the first return message (M2) from the second node (B) to the first node (A),
the third or first time measurement unit (CMT, AMT) is able to measure a seventh emitting time (T7) of the second outgoing message (M3) by the third or first node (C, A) and an eighth receiving time (T8) for the second return message (M4) by the third or first node (C, A),
the third or first calculation unit (CC, AC) of the third or first node (C, A) is able to calculate, from the seventh emitting time (T7), the eighth receiving time (T8) and the second known delay (TRA), the second travel time (Tac) of the second outgoing message (M3) or the second return message (M4) between the first node (A) and the third node (C),
the third calculation unit (CC) is able to calculate the third travel time (Tbc), from the second travel time (Tac), the first receiving time (T1), the second receiving time (T2), the first known delay (TRB) and the first information (INF1) indicating the first travel time (Tab), contained in the third message (M5).

7. The device according to claim 6, characterized in that the fourth message emitting and receiving unit (DER) of the fourth node (D) is able to emit, after a fourth known delay (TRD) after receiving the fourth outgoing message (M10), the fourth return message (M20),
the first time measurement unit (AMT) of the first node (A) is able to measure a ninth emitting time (T9) of the fourth outgoing message (M10) by the first node (A) and a tenth receiving time (T10) of the fourth return message (M20) by the first node (A), the first calculation unit (AC) is able to calculate, from the ninth emitting time (T9), the tenth receiving time (T10) and the fourth known delay (TRD), the fourth travel time (Tad) of the fourth outgoing message (M10) from the first node (A) to the fourth node (D) or of the fourth return message (M20) from the fourth node (D) to the first node (A),
the third calculation unit (CC) being able to calculate the fifth travel time (Tdc), from the third and fourth times (T3, T4), the second travel time (Tac), the fourth known delay (TRD) and the second information (INF2) indicating the fourth travel time (Tad), contained in the fifth message (M50).

8. The device according to claim 1, characterized in that the second outgoing message (M3) is combined with the first outgoing message (M1) and/or the fourth outgoing message (M10) is combined with the first outgoing message (M1).

9. The device according to claim 8, characterized in that the first travel time (Tab) is equal to
Tab={T6−T5−TRB}/2,
where Tab is the first travel time, T6 is the sixth receiving time, T5 is the fifth emitting time and TRB is the first known delay.

10. The device according to claim 9, characterized in that the second travel time (Tac) is equal to
Tac={T8−T7−TRA}/2,
where Tac is the second travel time, T8 is the eighth receiving time, T7 is the seventh emitting time and TRA is the second known delay.

11. The device according to claim 10, characterized in that the third travel time (Tbc) is equal to
Tbc=T2−T1−Tab−TRB+Tac,
where T2 is the second receiving time, T1 is the first receiving time, Tab is the first travel time obtained from the first information (INF1) contained in the third message (M5), TRB is the first known delay, and Tac is the second travel time.

12. The device according to claim 7, characterized in that the fourth travel time (Tad) is equal to
Tad={T10−T9−TRD}/2,
where T10 is the tenth receiving time, T9 is the ninth emitting time and TRD is the fourth known delay.

13. The device according to claim 7, characterized in that the fifth travel time (Tdc) is equal to
Tdc=T4−T3−Tad−TRD+Tac,
where Tdc is the fifth travel time, T4 is the fourth receiving time, T3 is the third receiving time, Tad is the fourth travel time obtained from the second information (INF2) contained in the fifth message (M50, M5) and TRD is the fourth known delay.

14. A relative localization method for at least one third node relative to at least one first node and at least one second node, where the first, second and third nodes are separated from each other,
characterized in that the first node (A) emits a first outgoing message (M1), to which the second node (B) responds with a first return message (M2),
the first node (A) calculates a first travel time (Tab) for the first outgoing message (M1) or the first return message (M2) between the first node (A) and the second node (B),
the first node (A) emits a third message (M5) containing a first information (INF1) indicating at least the first travel time (Tab),
the third or first node (C, A) emits a second outgoing message (M3), to which the first or third node (A, C) responds with a second return message (M4),
the third or first node (C, A) calculates a second travel time (Tac) for the second outgoing message (M3) or the second return message (M4) between the third node (C) and the first node (A),
the third node (C) receives the first outgoing message (M1), the first return message (M2) and the third message (M5),
the third node (C) measures a first receiving time (T1) for the first outgoing message (M1) and a second receiving time (T2) for the first return message (M2),
the third node (C) calculates a third travel time (Tbc) of the first return message (M2) from the second node (B) to the third node (C) from the first and second times (T1, T2), the second travel time (Tac) and the first information (INF1) indicating the first travel time (Tab), contained in the third message (M5).
